(19) United States
(12) Patent Application Publication
(10) Pub. No.: US 2005/0240459 A1
(43) Pub. Date: Oct. 27, 2005

(54) Virtual referral service

(76) Inventor: Steve Jon Cox, Capistrano Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/129,173

(22) Filed: May 13, 2005

Related U.S. Application Data
(63) Continuation of application No. 09/632,864, filed on Aug. 4, 2000, now abandoned.

(51) Int. Cl. G06F 17/60

(52) U.S. Cl. 705/8

(57) ABSTRACT

An on-line referral system. According to a preferred embodiment, individuals in need of having services rendered on their behalf post situations, preferably via a billboard maintained on a website. Service providers meeting certain competency thresholds capable and willing to perform services on behalf of such posted situations are enable to bid or otherwise forward advertising or promotional information to the individual posting such situation. In this respect, such posted situation is disseminated to those service providers capable of rendering such services on behalf of the individual. The individual may then consider the information, as submitted, and either select a particular service provider, or choose not to go with any service provider responding to such situation. In either event, the posted situation is caused to be terminated and withdrawn from the billboard. In further refinements of the invention, revenue may be generated by collecting subscription fees from service providers and/or fees from individuals for posting the situations.

### BACKGROUND OF THE INVENTION

Among the biggest challenges facing those with legal problems, financial difficulties, car or home repair needs, or any of a variety of situations where one is in need of help is finding the person or company most qualified to assist the individual in his or her time of need that willing to work at the most competitive price. For example, an individual faced with a serious legal problem and in need of immediate representation by an attorney must actively seek out counsel and actively solicit information regarding qualifications, experience, ability to provide representation and, most importantly, the fees to charged for rendering such services. Another example arises in the field of home construction and repair, which places an obligation on the individual in need of construction and/or repair to contract out one or more contractors, solicit a bid and, investigate references and do other important background screening measures.

As such, most individuals in need of such professional services and the like are relegated to searching through references, such as telephone book listings, and attempting to select which service provider (e.g., attorney, mechanic, contractor, plumber, etc.) is best suited for individual's needs and budget. As is frequently the case, however, the individual is overwhelmed with choices and literally must guess as to who would be best suited to perform a given task. Indeed, with respect to choice of lawyers, plumbers, contractors and the like, any given individual living in a major metropolitan area may have to decide among thousands of potential candidates. Even the Internet; which enables various professionals, tradesman and the like may now advertise and promote their services via on-line accessability, despite providing greater convenience and speed, still suffers from the drawback of not being readily responsive to the need for consumer information regarding the qualifications of a given service provider in a particular area, let alone the competency levels thereof and the fees normally charged thereby.

As such, while tremendous amounts of information are typically available through such conventional resources and the Internet, the amount of time that must be committed to thoroughly investigate all potential candidates/service providers for assistance in a given matter, let alone those that have been screened and believe to be the most desirable, makes the availability of such information almost worthless. These issues are especially difficult to address when one is unfamiliar with the needs of a given situation and forced to randomly select an individual or company in a short period of time while having no familiarity as to the background of the qualifications of such individual.

In order to address such shortcomings, it would be advantageous if a referral service were provided that placed the initiative on the service providers, as opposed the individuals in need of such services, to contact the individual in need of such services and provide information and pricing therefor. In this respect, it would be advantageous if an individual could simply post his or her problem, such as on a billboard maintained on a website, and thereafter allow various service providers capable and willing to render such services, preferably within a predetermined budget, to contact such individual and either bid on a particular task and/or provide such individual with information in order to advertise and promote the service provider's expertise in handling the particular task at hand.

As such, the individual would be provided with the specific information necessary to enable the individual to assess whether or not such service provider is best suited for the task at hand. There is further need in the art for such a referral system that, in addition to directing the service providers to the individual in need of such services, provides a screening function which only allows those service providers meeting certain competency threshold limits to have access to those individuals posting their situations in need of such services. There is yet a further need in the art for such a referral system that can be readily, easily, and inexpensively implemented via an on-line system which enables such referral activities to take place on-line over the Internet.

### SUMMARY OF THE INVENTION

The present invention specifically addresses and alleviates the above-identified deficiencies in the art. In this regard, the present invention is directed to a method for referring service providers and the like to individuals in need thereof via an on-line system. According to a preferred embodiment, an individual is provided a website for posting his or her situation, task, problem, etc., and invites a relevant group of service providers to evaluate the task, problem, etc., and thereafter provide bids or other information to the extent such service providers are willing and able to render such services for the given situation. The methol comprises the initial step of receiving from the individual a description of the problem, task, etc., as well as a set of criteria regarding the same. Such criteria includes the deadline by which such service must be rendered, the nature or the problem, any budgetary restraints, and any particular qualifications that the individual need of such services deems ideal for the particular situation. To the extent applicable, such criteria may further include the general vicinity where such services are to be rendered (e.g., a particular zip code or city) and whether or not any threshold competency criteria must be met in order to qualify to submit a bid or otherwise express interest in performing such services.

Once the criteria data along with the description of the task is submitted, such data is disseminated to a plurality of select, and preferably pre-screened service providers that, upon information or belief, are competent to render services for the particular situation. For example, an individual submitting criteria data directed to plumbing services will be disseminated to plumbers, whereas an individual in need of legal representation will be directed to attorneys. With respect to the latter, it is further contemplated that some specialties of law, (or any other service for that matter) will be take into consideration and that an individual in need of representation in a criminal or divorce matter will be directed to the appropriate defense or family law attorney, respectively.

Once dissemanated the various service providers having access to such website will be able to review the posted data and to the extent a given service provider is competent to perform such task, and is further willing and enable to perform such task, such service provider may either bid or submit advertising or promotional materials to the individual posting such criteria data through e-mail or other like communication means to thus provide the individual with the information and the ability to contact such service provider so the individual may, in turn, contact such service provider to render the relevant services. Preferably, each of the service providers having access to the posted criteria data will be pre-screened such that each meets certain minimal threshold competency levels to thus provide some means of assurance to the individual posting the task and related criteria that only qualified service providers will respond to such posted situation or task. In this respect, it is contemplated that in the case of attorneys, contractors, and the like that each will be appropriately certified and in good standing. It is likewise contemplated that such service providers may be required to obtain a subscription to gain access to the database of posted situations, possibly for a fee, which can yet provide further basis of selectively limiting the number of eligible service providers, as well as serve as a basis for obtaining information to document their respective abilities to render services on behalf of potential individuals posting situations via the methods of the present invention.

Once one or more service providers have been afforded the opportunity to review, bid and/or forward information to the individual posting such situation, the individual posting such situation will be able to review each bid or bids and thereafter initiate contact with the given service providers for purposes of negotiating consummating a transaction in relation to the posted task. In this respect, the individual posting such situation is given the control to pick and choose which service provider best suits his or her needs. Upon such occurrence, an obligation will be placed on the individual to remove the posted situation to thus terminate the ability of any service providers to compile and transmit data unnecessarily to the individual. Along these lines, to the extent the individual no longer needs to have a given situation addressed or, alternatively, is not satisfied with any of the choice of service providers interested in rendering services on behalf of the individual, the individual may voluntarily withdraw the posted situation at any time. In further refinements of the invention, the methods may further include compiling posted situations into various categories to facilitate the ability of various service providers to readily access those areas of professional relevance. It is also further contemplated that such methods may be coupled with relevant cross-referral methods such that service providers may be able to seek intra-system referrals to the extent desirable for such service providers to join forces to complete a given task. For example, an individual posting a situation requiring a general contractor can in turn cause such general contractors interested in bidding on such project to in turn post situations to entice subcontractors to provide their own bids in relation to specific aspects of a particular task.

It is therefore an object of the present invention to provide an on-line referral method that can enable an individual having a situation requiring services to be rendered on his or her behalf to be able to post such situation and cause those service providers capable and willing to perform such services on behalf of the individual to immediately respond thereto.

Another object of the present invention is to provide an on-line referral method that eliminates the requirement of an individual in need of having services rendered on his or her behalf to actively seek out and solicit information, background qualifications, pricing information, and the like from one or more service providers in order to assess whether or not a particular service provider is capable and will to perform tasks on such individual's behalf.

Another object of the present invention is to provide an on-line referral method that fosters competition between service providers by requiring each service provider to bid against one another in relation to rendering services on behalf of a given individual for a particular situation.

Another object of the present invention is to provide a an on-line referral method that enables an individual in need of having services rendered on his or her behalf with a method for screening service provider, interested in performing such services and insuring that each has met certain minimal competency thresholds levels and/or is good standing and competent to perform the task at hand.

Another object of the present invention is to provide an on-line referral method which is capable of generating revenue based upon a subscription fee chargeable to participant service providers, as well as through fees chargeable to individuals posting requests seeking to have services rendered on their behalf via the methods of the present invention.

Still further objects of the present invention include to provide an on-line referral method that can be easily, readily, and inexpensively implemented utilizing existing communications technology.

### BRIEF DESCRIPTION OF THE DRAWINGS

These, as well as other features of the present invention, will become apparent upon reference to the drawings wherein:

FIG. 1 is a flow chart illustrating the various steps involved in the practice of the methods of the present invention, according to a preferred embodiment.

### DETAILED DESCRIPTION OF THE PREFERRED EMBODIMENT

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

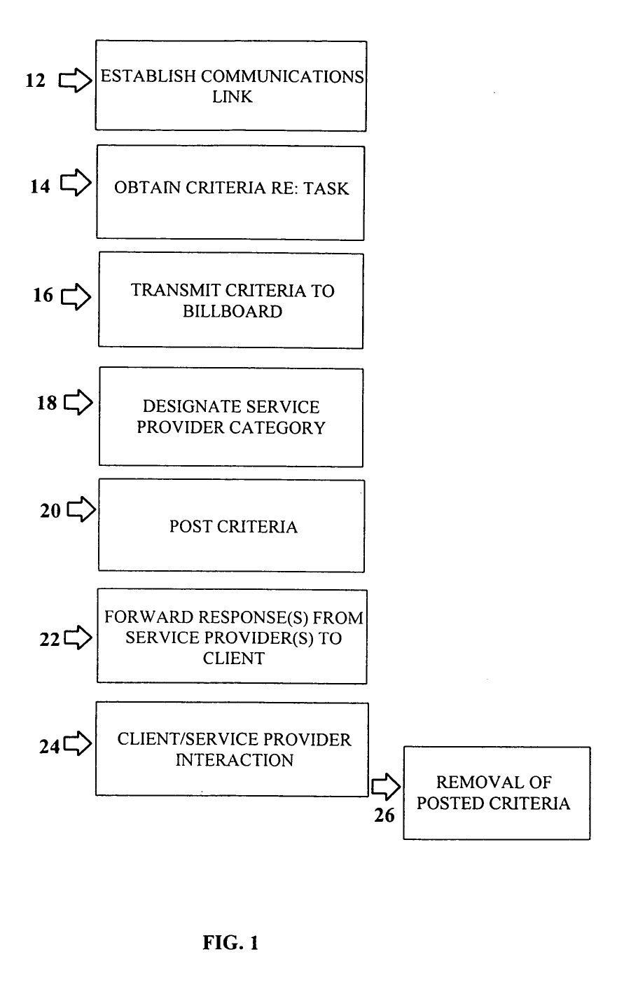

Referring now to FIG. 1, there is depicted a flow chart depicting the various steps for performing the on-line referral methods of the present invention. In this regard, the present invention is directed to novel and unique methods for enabling service providers to evaluate and bid on tasks or situations that such service providers can and are willing to render based upon an evaluation of a given set of criteria posted by an individual, preferably by an electronic billboard maintained by a website. In this respect, individuals in need of having services rendered on their behalf, need only post the particulars regarding their specific situations and, as opposed to having to actively seek out one or more service providers and confirm the provider's qualifications, price information, and the ability to schedule work, such information is already provided to such individual directly from the service provider. Accordingly, the present invention is directed toward eliminating the task of requiring individuals to seek out such service providers, but rather requires such service providers to initiate and compete against one another to perform the subject work based upon the criteria posted. In a further refinement of the present invention, it is contemplated that the methods disclosed herein may be utilized to generate revenue by charging a fee for each individual seeking to post his or her situation.

At the outset, it is believed that the methods of the present invention can encompass virtually every type of service capable of being rendered. For example, it is contemplated that service providers may include the rendering of professional services, such as legal counsel, accounting and the like, or may relate to particular trades, such as plumbing, automobile repair, construction, computer networking, and so on. Accordingly, for purposes of the present application, it should be understood that the term service provider should be construed as broadly as possible to encompass any type of service that can be rendered on behalf of an individual or company.

With respect to deployment of the methods of the present invention, it is presently envisioned that the same will necessarily be accomplished over a global computer network, namely, the Internet. As appreciated by millions, the Internet is a system of linked computers that permit fast, low-cost global communication, entertainment, and information exchange, and hence is the primary vehicle by which the methods of the present invention may be practiced. It should be understood, however, that while the present invention as described herein is embodied in such network (i.e., the Internet), the invention is not limited in this respect and may be embodied in any data communications system wherein a system requests data from a client, via a content server, and thus may include, but by no means limited to on-line information services, telephone networks, and television networks.

As illustrated, the method 10 comprises the initial step 12 of establishing a communication link between an individual in need in having services rendered on his or her behalf and an electronic billboard of messaging system. With respect to the latter, it is contemplated that the same may take the form of any of a variety of bulletin boards operated on conventional websites. Once the communication link has been established with the individual, criteria is obtained from the individual via step 14. In this regard, the criteria is representative of the specifications and parameters pertinent to the particular task or situation specific to the individual's needs. As will be appreciated by those skilled in the art, such criteria data will include a description of nature of the problem, task, etc., the time frame by which services would preferably be rendered, budgetary information regarding preferred price ranges that the individual is willing to expend, and any other pertinent information regarding particular qualifications that a particular service provider must necessarily possess in order to accomplish the specified task. The individual must further necessarily indicate any geographic restrictions pertinent to the particular situation or task, namely, whether or not the service is to be rendered must be done so in a particular location or geographic vaccinating. For example, to the extent plumbing services are utilized, it will be imperative that the individual transmit the whereabouts such services are to be rendered. The individual will further specify how the individual is to be contacted, either by e-mail address, fax, mail, or any other type of conventional communication means.

As an illustration, an individual in need of legal representation for a particular matter would submit criteria data indicative of the nature of the legal problem (e.g., the service of a complaint, criminal charges, etc.), any deadlines the individual is aware by which immediate services are to be rendered (e.g., an answer to a complaint, appearance at an arraignment, etc.), and what lump sum or hourly fee the individual is willing to pay for such services. Although not essential, the individual may state further criteria regarding minimal competency threshold levels that any service provider interested in undertaking to render services on behalf of the individual must possess. For example, in the case of legal representation, the individual may state whether or not the attorney should have a requisite number of years of experience, certain academic qualifications, or a specific “track record” with regard to previous successes and failures.

As currently envisioned, the criteria obtained in step 14 is transmitted to a remote location via step 16, which will comprise a website accessed by the communication link. Upon submission of the criteria obtained from the individual, such criteria is designated in step 18 into an appropriate category for a particular population of service providers. As will be appreciated, criteria data pertaining to construction matters will necessarily be provided in one category, legal issues will fall into a separate category, and so on. In this respect, it is contemplated that an indexing and categorization system will be deployed which will appropriately designate given tasks and criteria in correspondingly appropriate categories.

Once appropriately categorized, the criteria is then posted in step 20, preferably via a dedicated website For example, plumbers qualifying as service providers according to the present invention will be able to access those posted situations regarding plumbing, certified and pre-screened attorneys will be able to access those posted situation regarding legal representation and so on. In this respect, it is contemplated that such website will be maintained which may only be accessed by select service providers meeting certain qualifications (utilizing access-limiting techniques known in the art). Specifically, it is contemplated that the methods of the present invention will only utilize those service providers that have met certain competency thresholds and are in good standing with respect with their particular profession/occupation. For example, any attorneys qualifying to participate as service providers in the methods of the present invention will necessarily be in good standing, and preferably will have little or no history of complaints. Likewise, all trades (e.g., plumbers, electricians, contractors, etc.) will necessarily possess the proper certification and licensing. In this regard, it is contemplated that a database will be maintained that is continuously updated with service providers qualified to render services for a particular situations. For example, all tradesmen will be preferably periodically reviewed, via state board licensing procedures to ensure that each retains good standing status. As will be appreciated, by undertaking to periodically review each service provider, there is thus provided a level of quality assurance and competency to the extent any qualifying service provider is referred to a particular individual, as discussed more fully below.

In a further refinement of the present invention, it is contemplated that such service providers, in addition to meeting certain competency threshold levels, may further necessarily pay a subscription fee in order to gain access to the posted situations. In this respect, it is contemplated that access to the website where such situations are posted will be selective, as per convention website practices whereby access is restricted.

Once a particular service provider has had an opportunity to evaluate a posted situation, he or she may be able to respond thereto, via step 22, by bidding on the particular task or otherwise forwarding advertising and promotional materials to thus indicate to the individual posting such situation the service provider's capabilities and willingness to render services on the individual's behalf. In this respect, it is contemplated that the service providers interested in rendering services will transmit such data to the individual or some designated website address as per conventional practices. Preferably, the service provider will forward such information as specified by the individual via his or her posted criteria.

Upon receipt of the responses and/or bids provided by those service providers interested in rendering services on behalf of the individual, the individual is then allowed to evaluate such responses and thereafter negotiate with one or more of the service providers directly in step 24. As will be specific to each particular situation, the individual posting his or her situation will have the leeway to pick and choose which service provider he or she believes is best suited for the task at hand, which may include not utilizing any particular service provider responding to the posted situation. In any event, such decision will ultimately rest with the individual and will thus foster competition between the various service providers. In this respect, the methods of the present invention advantageously dispenses with the need of the individual to actively seek out one or more service providers, but enables the service providers to immediately express their capability and willingness to perform such tasks, as well as their interest in competing with other providers.

To the extent the individual proceeds to consummate a transaction with one or more of the service providers, chooses to forego hiring any particular service provider, and/or the individual no longer requires services to be rendered on his or her behalf, the posted situation with related criteria is removed from the billboard upon which the same is posted in step 26. In this respect, the individual, when submitting the criteria data, the individual will preferably indicate the relevant time frame by which its services are to be rendered so as to enable the service providers to timely respond such that only realistic opportunities to render services are considered. In further refinement of the invention, it is contemplated that such posted situations will only have a fixed duration (e.g., 2-60 days), after which time such posted situation will automatically be removed. Moreover, it is contemplated that due to the certain geographic constraints, only those situations that can be realistically performed in a given area (e.g., zip code, particular city, etc.) will only be disseminated to those service providers having the realistic capability of rendering services for such particular situation. For example, an individual in need of plumbing services in the city of Los Angeles will preferably only have his or her situation posted or made accessible to service providers capable of rendering services in the Los Angeles area. As will be appreciated, by placing such geographic limitations, the individual in need of such services will not be provided with unrealistic offers to render services in relation to a particular situation.

In addition to the foregoing methods for providing general referrals, it is contemplated that the methods of the present invention may be used for intra-referrals as well. In this respect, it is contemplated that to the extent one or more service providers must necessarily utilize other service providers, as typically occurs in the context of a general contractor utilizing subcontractors to render construction services for an overall project, it is believed that the methods of the present invention may be deployed in such a manner whereby a general contractor may post separate situations to other subcontractors, such as plumbers, electricians, and the like, so as to solicit bids for incorporation to a larger bid, as is the typical practice in the reconstruction industry.

As will be recognized, it is to be understood that various additions, deletions, modifications and alterations may be made to the above-described embodiments of the method of the present invention without departing from the intended spirit and scope thereof. For example, it is believed that the novel methods of the present invention may be deployed and administered over fixed geographic areas via a franchise-type arrangement. Specifically, it is contemplated that website systems administrators over a plurality of local areas may be responsible for maintaining and updating the database of suitable service providers, as well as modifying the identification and selection procedures that a particular service provider must ideally meet in order to be provided with access to posted situations. Additionally, although presented in the context of services, it is further contemplated that the same may be utilized in relation to the sale of goods, such as cars, electronic equipment and the like, whereby vendors, as opposed to purchasers, express their willingness to sell one or more items for a particular price. Accordingly, it is intended that all such additions, deletions, modifications, alterations be included within the scope of the following claims.

1. A method for soliciting services to be rendered by a service provider in relation to a specified task on behalf of an individual over at least over one computer network where in said network connects at least one personal computer associated with said individual to at least one information-provider computer, the method comprising the steps:
a) obtaining criteria from said individual determinative of the nature of the task to be performed;
b) comparing said criteria obtained in step a) with a database of known service providers;
c) identifying and selecting a group of a service providers in step b) having capability to render services in relation to the task as specified in the criteria set forth in step a);
d) disseminating said criteria obtained in step a) with said service providers identified in step c);
e) generating at least one response from at least one service provider having received said criteria in step d); and
f) forwarding said at least one response obtained in step e) to said individual.

2. The method of claim 1 wherein in step a), said criteria comprises of information selected from a group consisting of the nature of the task, the time frame by which such task is to be performed, the fixed sum that which such task is to be performed, and the geographic area such task is to be performed.

3. The method of claim 2 wherein in step a) further comprises obtaining criteria information including at least on qualification of a service provider.

4. The method of claim 1 wherein in step a), said task and criteria are related thereto pertain to legal services; and wherein in steps c) and d), said service providers comprise attorneys.

5. The method of claim 1 wherein in step a), said task and criteria are related thereto pertain to construction services; and wherein steps c) and d), said service providers comprise licensed contractors.

6. The method of claim 1 wherein in step a), said task and criteria are related thereto pertain to plumbing services; and wherein in steps c) and d), said service providers comprise plumbers.

7. The method of claim 1 wherein in step a), said task and criteria are related thereto pertain to electrical services; and wherein in steps c) and d), said service providers comprise electricians.

8. The method of claim 1 wherein in step a), said task and criteria are related thereto pertain to accounting services; and wherein in steps c) and d), said service providers comprise accountants.

9. The method of claim 1 wherein in step a), said task and criteria are related thereto pertain to automobile repair services; and wherein in steps c) and d), said service providers comprise automobile mechanics.

10. The method of claim 1 wherein in step a), said task and criteria related thereto pertain to real estate sale services; and wherein in steps c) and d), said service providers comprise real estate brokers.

11. The method of claim 1 wherein in step a), said task and criteria related thereto pertain to sub-contracting construction services selected from the group consisting of plumbing services, electrical services, framing services, drywall services, concrete pouring services, and said service providers selected in steps c) and d) will comprise subcontract service providers namely plumbers, electricians, framers, drywallers and cement contractors.
